(19) United States
(12) Patent Application Publication
(10) Pub. No.: US 2009/0277055 A1
(43) Pub. Date: Nov. 12, 2009

(54) CABLE IDENTIFIER

(76) Inventors: David Madrigal, Houston, TX (US); Valerio Varela, Metairie, LA (US)

Correspondence Address: LAW OFFICE OF DAVID MCEWING, P.O. BOX 231324, HOUSTON, TX, 77023, US

(21) Appl. No.: 12/116,332

(22) Filed: May 7, 2008

(51) Int. Cl. G09F 3/00

(52) U.S. Cl. 40/316

(57) ABSTRACT

The disclosure taught by the specification is for a cable identifier comprised of an equipment symbol or equipment name, a fastener component further comprising an encircling band fastener with a releasable encircling band attachment, and foam affixed to the inner circumference of the band attachment. The cable identifier can have multiple identifier surfaces containing permanent symbols or equipment names. The foam attachment, combined with the variable sized band diameter holds the cable identifier securely to the cable in an area convenient for later identification of cable.

### BACKGROUND OF INVENTION

1. Field of Use

Marking or otherwise identifying electrical cables, i.e., cables conveying electrical power or electrical signals.

2. Related Technology

Wire ties and tapes have been used to identify electrical wires. There are products available in the market such as “Cable Ties” from Case Logic and “clarkcable” Wire Identifier from Westminister industries.

### SUMMARY OF DISCLOSURE

A cable identifier comprised of an equipment symbol or equipment name with an adjustable fastener component such as an encircling band fastener with a releasable clip attachment, and foam or similar soft, flexible substance affixed to the inner circumference of the circular clip. The foam and the variable band can securely fasten the cable identifier to the electrical cable.

### SUMMARY OF DRAWINGS

The accompanying drawings, which are incorporated in and constitute a part of the specification, illustrate embodiments of the invention. These drawings, together with the general description of the invention given above and the detailed description of the embodiments given below, serve to explain the principles of the invention.

FIG. 1 illustrates an electrical cable containing a permanent identifier of a printer symbol and the word text “printer”.

FIG. 2 illustrates a side view of a cable identifier attached to an electrical cable wherein two identifiers are mounted on the cable identifier band.

FIG. 3 illustrates an embodiment of a cable identifier comprised of a cable band with interior foam lining and a side view of a cable identifier.

FIG. 3a illustrates another view of the cable identifier showing the band attachment mechanism snapped into place.

FIG. 4 illustrates a side view of another embodiment wherein the identifier band comprises slots through which the band end (not shown) can be inserted.

FIG. 5 illustrates a side view of a cable identifier containing two identifiers and an unclosed band closing mechanism with soft flexible lining. The band contains a protrusion component that snaps into a closing component.

FIG. 6 illustrates a side view of a cable identifier with a plurality of holes for inserting the band end.

FIG. 6a illustrates a side view of a cable identifier with the band closing mechanism closed having a plurality of holes where a protrusion component as shown in FIG. 5 can snap into.

FIG. 7 illustrates a typical electrical power strip attached to an electrical wall outlet with multiple electrical appliances connected to the power strip. Cable identifiers are shown next to the electrical cables plugged in at the power strip but also counterpart cable identifiers are shown adjacent to the appliances.

FIG. 7a illustrates a variety of different wires and cables that can be plugged into a single power strip.

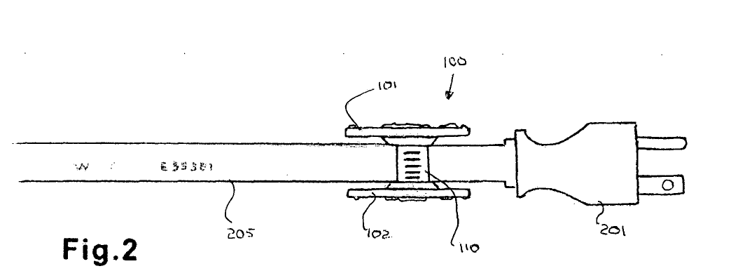

In addition, FIGS. 2, 3, 3a, 4, 5, and 6a show a side profile of the permanent marking of the identifier. Shown in side profile is the appliance symbol and appliance name.

### DETAILED DESCRIPTION OF DISCLOSURE

While this invention is susceptible of embodiments in many different forms, there is shown in the drawings and will herein be described in detail embodiments of the invention with the understanding that the present disclosure is to be considered as an exemplification of the principles of the invention and these examples are not intended to limit the broad aspect of the invention. The above general description and the following detailed description are merely illustrative of the subject invention and additional modes, advantages and particulars of this invention will be readily suggested to those skilled in the art without departing from the spirit and scope of the invention.

The disclosure pertains to a novel product and method for identifying cables carrying electrical power or carrying electrical signals, (hereinafter “electrical cables”). The device is plastic that can be bent, curled or straighten.

In one embodiment, the device is formed in a curled shape with a plastic closing mechanism. When closed, the device approximates an o-ring which can circumvent the electrical cable. The device bands the electrical cable. The encircled electrical cable is thereby identified. The closure can utilize a latch mechanism so the cable identifiers can be reused.

The soft, flexible lining e.g., foam, can extend inwardly from the interior diameter of the cable identifier band. The lining thereby contacts the electrical cable. The lining may be pressed against the electrical cable thereby holding the cable identifier in place on the electrical cable. It will be appreciated that the lining thickness may vary. A thick layer of foam will allow the identifier device to snuggly hold a relative small diameter, e.g., a USB cable.

The band closure may also be adjustable, i.e., the diameter of the cable identifier can be made alternatively larger or smaller. The cable identifier also includes at least one identifier component. This will be a surface area that may contain the name of the appliance served by the electrical cable, an icon or symbol representing the appliance, or a color selected for that appliance. The appliance name or appliance icon, i.e., symbol, may be permanently marked on the surface of the identifier component. This can be superior to markers that rely upon adhesive stickers that dry up and fall away over time. In one embodiment, there are two identifier components. Each component may be placed approximately 180 degrees from the other on the cable identifier band.

One embodiment is directed to the remedy the clutter of electrical cables that often co-exits with a computer, and ancillary components such as a printer, copier, scanner, fax machine, telephone, electrically powered speakers, desk lamps and other lights, paper shredders, routers, Ethernet cables, etc. Frequently multiple power strips are used and connected to separate electrical wall outlets. The power strips typical include a surge protector for the protection of the connected appliances.

Typically one or more computers are in use. Each may have a plethora of electrical cable connected to the back of the computer. It is not an uncommon experience to have to climb under a desk, often with a flash light, to sort out the clutter when adding or changing appliances. The present disclosure permanently simplifies this process.

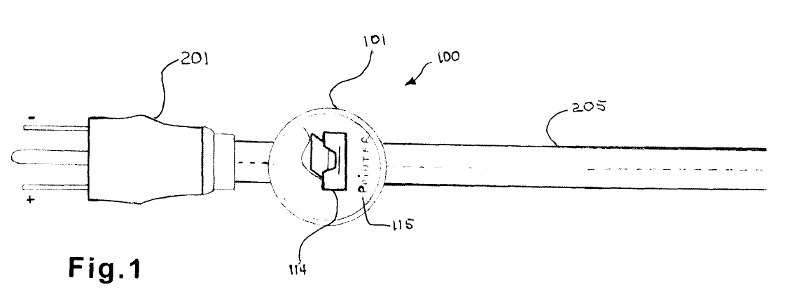

FIG. 1 illustrates an electrical cable 205 containing a permanent identifier 100 of a printer symbol 114 and the word text “printer” 115. The identifier surface 101 is large and legible. The surface of the identifier may be of multiple colors to enhance the visibility of the appliance symbol or the appliance name. The cable identifier is banded around the electrical cable. It may be placed proximate to the electric cable plug 201 which may be connected at either a wall outlet or power strip. Only one identifier is visible in FIG. 1, however, multiple identifiers may be placed upon the banding component of the cable identifier.

FIG. 2 illustrates a side view of a cable identifier 100 attached to an electrical cable wherein two identifier surfaces 101, 102 are mounted on the cable identifier band 110. It will be appreciated that the different banding mechanisms may be employed as discussed below. The attachment mechanisms can be configured to allow the diameter of the encircling band variable to adjust for the variable size of the electrical cable. Again, the cable identifier is attached to the electrical cable 205 proximate to the electrical plug 201.

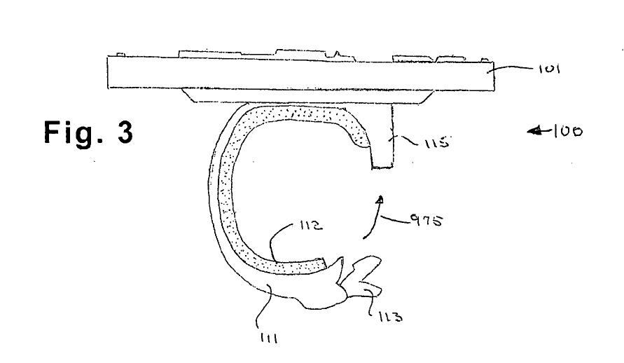

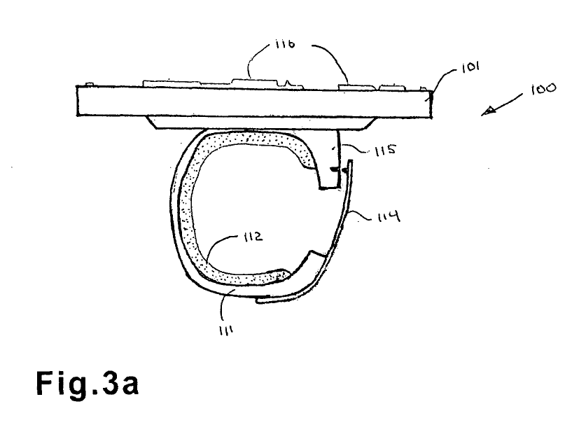

FIG. 3 illustrates an embodiment of a cable identifier 100 comprised of a cable band 111 with interior foam lining 112 and a side view of an identifier surface 101 with the raised permanent lettering or symbol. The band closes with a clip mechanism 113. The band is made of plastic, e.g., polyethylene or similar material and therefore has the flexibility to bend in the direction of vector arrow 975 to close the clip mechanism.

The interior surface of the band is shown to be coated with foam 112 or similar material. This can allow the interior of the band to achieve frictional contact with the electrical cable. The foam can be open or close cell foam. However close cell may be preferable. The foam may be polyurethane or polystyrene. Other materials may include a viscoelastic polymer, a cushioning gel like material that can have a degree of tackiness or gripping characteristic to the touch. Viscoelastic polymers demonstrate properties of both viscosity and elasticity. They cushion the cables and simultaneously grip the electrical cables to hold the cable identifiers in place. They are flexible with a high density to maintain long contact with electrical cables without loss of elasticity. Another material may be silicon based soft plastic polymers commonly used in fishing tackle and having a soft rubbery feel.

FIG. 3a illustrates another view of the cable identifier showing the band attachment mechanism 114 snapped into place. A piece attached to the band 111 spans the opening and closes with piece 115. The attachment mechanism may have a removable attaching protrusion that snaps into a like dimensioned aperture in band extension 115.

In another embodiment, the protrusion may be on band extension 115 and the attaching mechanism 114 may contain multiple apertures. This enables the diameter of the cable identifier to be adjusted. This can allow the cable identifier to adapt to a three wire power cable, a coaxial cable or a telephone wire. It may also serve to bundle multiple wires together that serve the same appliance.

Note again that the interior of the band is coated with a foam or similar material. The foam may be attached to the band with an adhesive. Also note the lettering or raised components of the appliance symbol 116 are visible on the identifier surface 101.

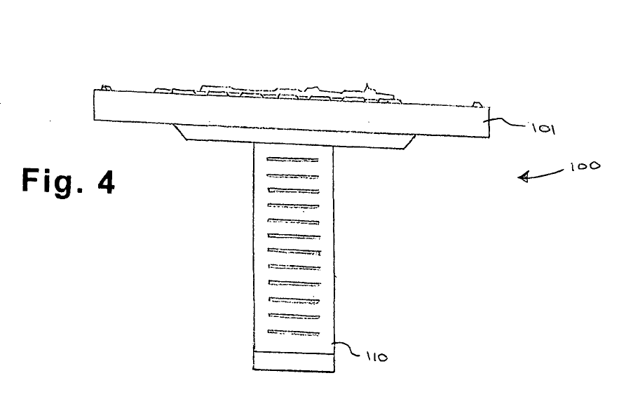

FIG. 4 illustrates a side view of another embodiment wherein the identifier band 110 comprises slots through which the band end (not shown) can be inserted. Insertion of the end closes the band. The length of the end that can be pulled through the loop determines the diameter of the band. Combined with the foam lining (not shown) the cable identifier 100 can be adjusted for the diameter of electrical cable. In one embodiment, the band end can also be removed from the band slots.

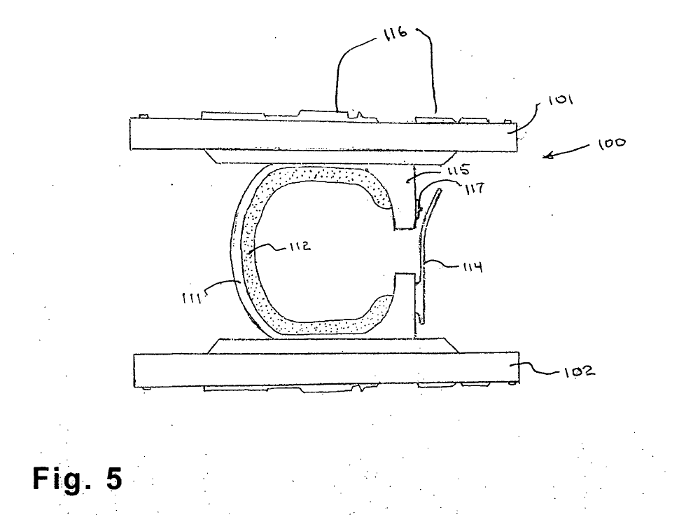

FIG. 5 illustrates a side view of a cable identifier containing two identifier surfaces 101, 102. The raised appliance symbol or lettering 116 is visible on the identifier surface. The diameter of the band is adjustable by selecting multiple holes in the attachment piece 114 to fit with the protrusion 117 on the band extension 115. Again the inside of the band contains foam 112 or other flexible material that serves to hold the cable identifier to the electrical cable. The thickness of the foam or flexible material may be varied to decrease the inner diameter of the band.

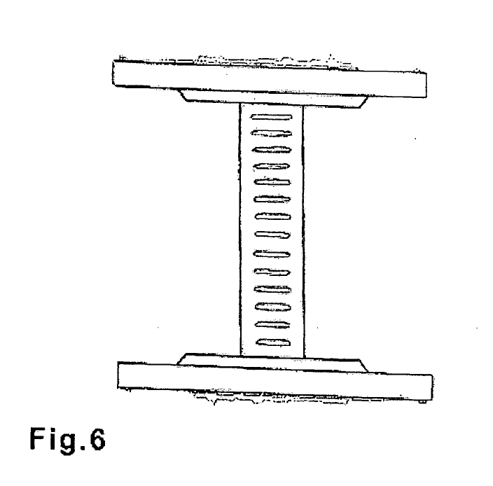

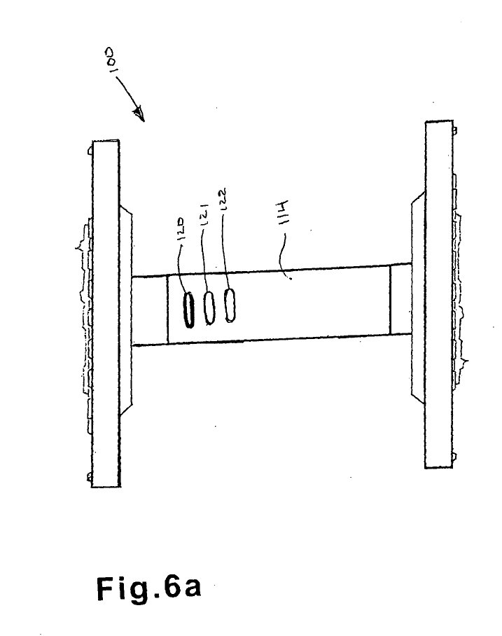

FIG. 6 illustrates a side view of a cable identifier 100 with a band attachment comprised of a plurality of holes through which the end of the band may selectively be inserted. Insertion through any of the holes will lock the band end. The hole can be selected that will hold the cable identifier with the desired level of tightness to the cable(s).

FIG. 6a illustrates a side view of a cable identifier 100 with the band attachment mechanism 114 closed. The attachment mechanism is shown with three openings 120, 121, 122 into which the protrusion shown in FIG. 5 can fit. Using this mechanism, the diameter of the cable identifier can be adjusted for the cable size or size of the cable bundle.

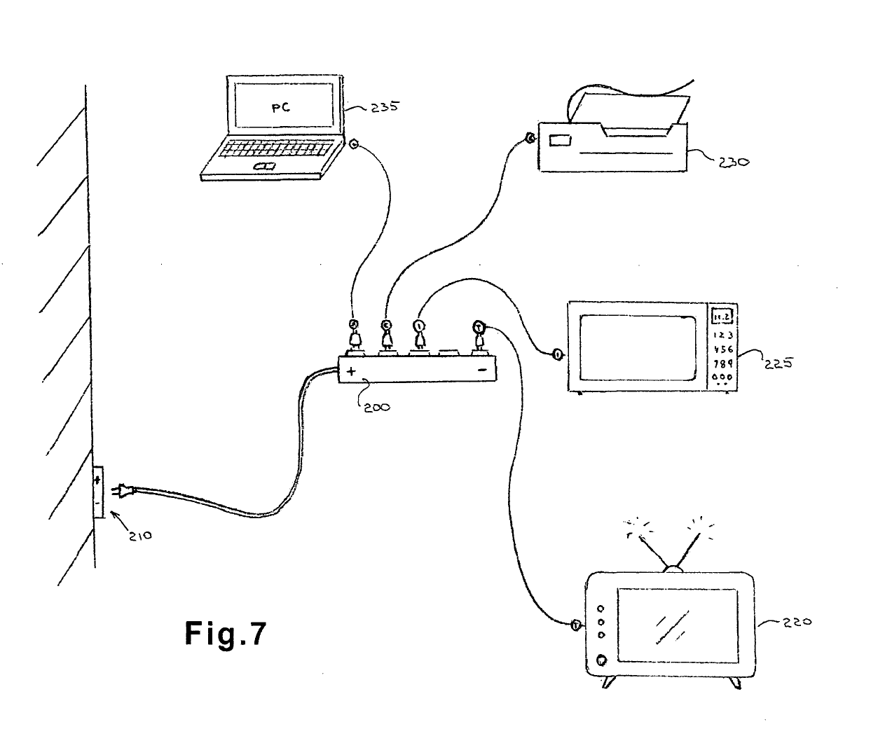

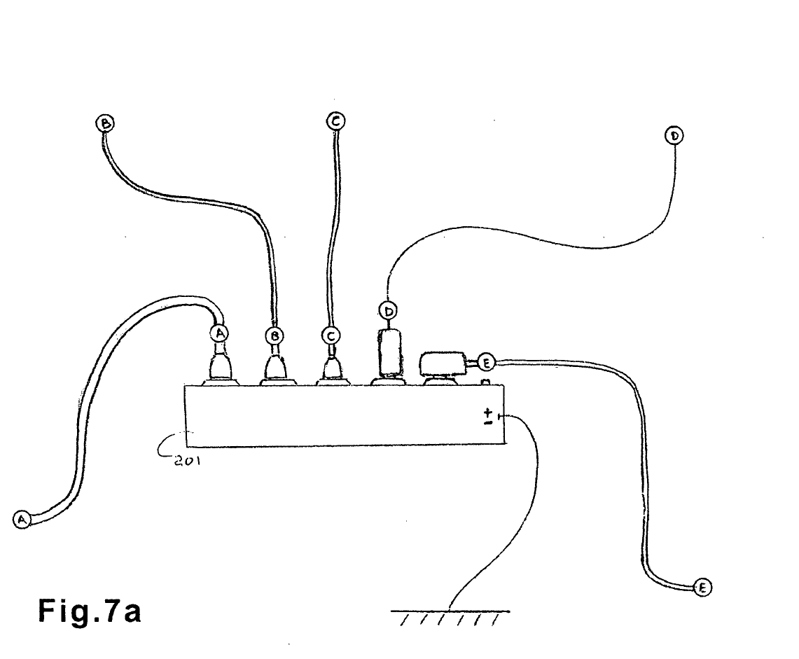

FIG. 7 illustrates a typical electrical power strip attached to an electrical wall outlet with multiple electrical appliances connected to the power strip 200. Cable identifiers are shown not only next to the electrical cables plugged in at the power strip but also counterpart cable identifiers adjacent to the appliances.

Also illustrated are the wall outlet 110, television 220, microwave 225, printer 230, laptop computer 335.

FIG. 7a illustrates a power strip 201 with multiple wires and cable plugged in. Note the varying diameters of the wires.

In addition, FIGS. 2, 3, 3a, 4, 5, and 6a show a side profile of the permanent marking of the identifier. Shown in side profile is the permanent raised appliance symbol and appliance name. These can be multiple colors.

While specific embodiments have been illustrated and described, numerous modifications are possible without departing from the spirit of the invention, and the scope of protection is only limited by the scope of the accompanying claims. This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

What we claim is:

1. A cable identifier comprised of:
a) an equipment symbol or equipment name;
b) a fastener component further comprising an encircling band fastener; and
c) a soft flexible liner comprising a foam or a cushioning gel material such as a viscoelastic polymer or silicon based plastic polymer having a soft rubbery feel affixed to the inner circumference of encircling band.

2. The cable identifier of claim 1 further comprising a releasable or removable attachment for the encircling band further comprising a removable protrusion that snaps into one of a plurality of complementary dimensioned aperatures whereby the circumference of the encircling band is adjustable.

3. The cable identifier of claim 1 further comprised of a second identifier for use identifying a second end of a cable.

4. The cable identifier of claim 1 further comprising the equipment symbol or equipment name in a plurality of colors.

5. The cable identifier of claim 1 further comprising the encircling band with a releasable and adjustable fastener with two equipment symbol or equipment name identifier components.

6. The cable identifier of claim 5 further comprising the two equipment symbol or equipment name identifier components affixed to opposite sides of the encircling band fastener.

7. (canceled)

8. (canceled)

9. (canceled)

10. The cable identifier of claim 1 further comprising foam or cushioning gel material of a diameter to hold the cable identifier to a cable by friction and further comprising a band attachment mechanism comprising a removable protrusion that snaps into one of a plurality of complementary dimensioned aperatures whereby the circumference of the encircling band is adjustable.

11. (canceled)

12. A cable identifier of claim 6 further comprising an encircling band fastener that allows the diameter of the band to be adjusted by a band attachment mechanism comprising a removable protrusion that snaps into one of a plurality of complementary dimensioned aperatures or a plurality of apertures in the encircling band through which the encircling band end can be inserted whereby the circumference of the encircling band is adjustable.

13. A cable identification system comprising:
a) a first cable identifier placed on a cable attached to a wall outlet or power strip;
b) at least one second cable identifier placed on a cable proximate to the appliance served by the cable;
c) a soft flexible liner comprising a foam or a cushioning gel material such as a viscoelastic polymer affixed to an inner circumference of the cable identifier.

14. The cable identification system of claim 13 further comprising the first and second cable identifier are the same color and a different color from at least one other identifier.

15. The cable identification system of claim 13 wherein the appliance name or appliance symbol is marked by a user.

16. The cable identification system of claim 15 wherein the appliance name or appliance symbol is contained on an adhesive sticker.

17. The cable identification system of claim 13 wherein the appliance identification is permanently affixed to the cable identifier.

18. The cable identification system of claim 13 wherein the appliance identifier is held behind a clear plastic cable identifier.

19. The cable identifier of claim 1 further comprising a releasable or removable attachment for the encircling band comprising a plurality of apertures in the encircling band through which the encircling band end can be inserted whereby the circumference of the encircling band is adjustable.
